(19) United States
(12) Patent Application Publication
(10) Pub. No.: US 2002/0141144 A1
(43) Pub. Date: Oct. 3, 2002

(54) Simple pocket assistant

(76) Inventor: Anurag Prakash, Chandler, AZ (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/819,292

(22) Filed: Mar. 27, 2001

(51) Int. Cl. G06F 1/16

(52) U.S. Cl. 361/683; 361/730

(57) ABSTRACT

A computer system is formed by coupling at least two modules to one another. The at least two modules includes a first module and a second module. Each of the first module and the second module has a display screen such that when the first module and the second module are placed adjacent to each other, the display screen of the first module and the display screen of the second module form a viewing area. The first module and the second module have components to form a computer.

### FIELD OF THE INVENTION

The present invention relates generally to field of computer design. More specifically, the present invention is directed to a module method for forming computer systems.

### BACKGROUND

In an ever-changing global world, the need for mobile computing is expanding. Whether it is an executive on a transatlantic flight, a sales manager downloading the latest product description from the Internet or a student preparing a class report, the flexibility provided by mobile computing has made mobile computing devices becoming essential productivity tools.

The popularity of these mobile computing devices has risen as their costs and sizes have diminished. For example, it is now routine for business travelers to carry lap top computers, cellular phones and personal data assistants (PDA). Mobile computing devices play a key role in improving decision-support, productivity and time management. The diminished size means more mobile computing devices can be designed to fit into pockets.

In spite of the popularity of these mobile computing devices, each of them is designed for a specific purpose. For example, the lap top computer is used for computing, the mobile phone is used to make stay in touch or to connect the laptop computer to a communication network, and the PDA is used to keep track of important information such as calendar, e-mail, address book, to do lists, expense lists, memos, etc.

Furthermore, there are limitations to some of these mobile computing devices. For example, a cellular phone or a PDA may offer Web browser functions but many people do not use the Web browser functions because of the small display area and limited computing power of these devices. Scrolling on a small display proves to be too inconvenient. In addition, cellular phones and PDAs generally do not have good interfaces to peripheral devices such as, for example, printers.

It would be advantageous to have a mobile computing device capable of providing all of the functionalities of the mobile computer, mobile phone, PDA, etc.

### BRIEF DESCRIPTION OF THE DRAWINGS

The present invention is illustrated by way of example in the following drawings in which like references indicate similar elements. The following drawings disclose various embodiments of the present invention for purposes of illustration only and are not intended to limit the scope of the invention.

FIGS. 1A and 1B illustrate a front view, a back view and a side view of an exemplary module of a mobile computing device according to the present invention.

FIG. 2 is an illustration of two exemplary attached modules of the mobile computing device.

FIG. 3 is an illustration of two exemplary attached modules unfolded in an open position.

FIG. 4 is an exemplary illustration of two modules folded in a back-to-back open position.

FIG. 5 is an exemplary illustration of internal components in a mobile computing device according to the present invention.

FIG. 6 is an exemplary illustration of a mobile computing system with three modules in a side-to-side open position.

FIGS. 7A and 7B provide exemplary illustration of a mobile computing device having multiple modules.

### DETAILED DESCRIPTION

There is a need for mobile computing devices that are configurable to be in different forms for different situations. Using a modular approach, a mobile computing device may be configured to operate in different modes such as, for example, as a laptop computer, as a personal digital assistant (PDA), as a cellular phone, etc.

In the following description, for purposes of explanation, specific nomenclature is set forth to provide a thorough understanding of the present invention. However, it will be apparent to one skilled in the art that these specific details are not required in order to practice the present invention. Some portions of the detailed descriptions that follow are presented in terms of symbolic representations of operations on data bits within a computer memory. These representations are the means used by those skilled in the data processing arts to most effectively convey the substance of their work to others skilled in the art. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

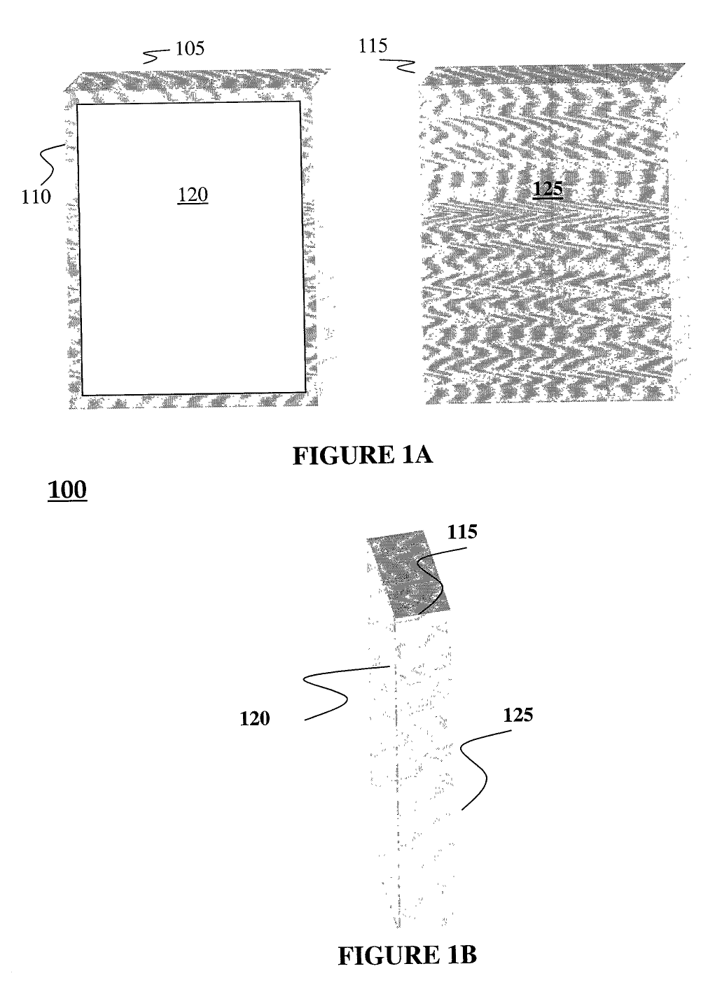

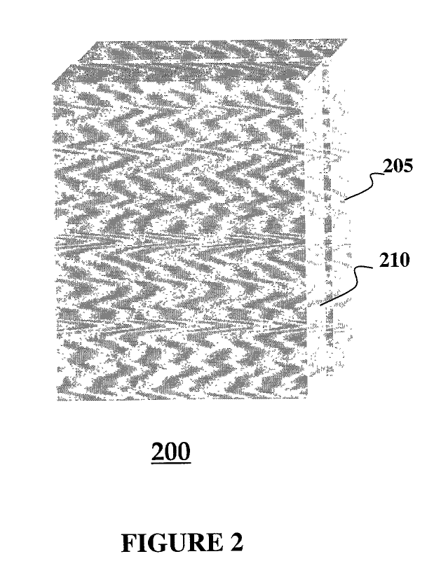

FIGS. 1A and 1B illustrate a front view, a back view and a side view of an exemplary module of a mobile computing device according to the present invention. The module 100 has a front side 120 and a back side 125. In one embodiment, the front side 120 is a display screen (e.g., LCD screen, etc.), and the back side 125 is part of an enclosure of the module 100. Height 110, width 105 and thickness 115 of the module 100 may be designed to easily slide into most pant pockets. For example, the height 100 may be 14 cm, the width 105 may be 10 cm, and the thickness may be 4 cm.

In one embodiment, the display screen on the front side 120 is a touch screen display. For example, the display screen may be a thin liquid crystal display (LCD). The display screen is used as a viewing area. Space behind the display screen and inside the disclosure is utilized for implementing hardware logic such as, for example, circuits, memory chips, batteries, processor, etc.

FIG. 2 is an illustration of two exemplary attached modules of the mobile computing device. The module 210 and the module 205 may be attached to each other by a hinge or a slide in an arrangement that allow them to fit together. Other attachement technique may also be used. The mobile computing device 200 may have a different personality (i.e., operate in different mode) depending on orientation of its modules.

Referring to FIG. 2, the module 210 and the module 205 may be folded together such that the display screen of each of the modules 210 and 205 face each other. This is referred to as a closed position and the display is not visible. This closed position may be used when the mobile computing device 200 is not in use. Various components making up the mobile computing device 200 may be powered off or set in a low power setting to conserve power. In one embodiment, the mobile computing device 200 does not have a visible power-off switch, and the action of placing the modules 210 and 205 in the closed position may automatically triggers a power switch which set the mobile computing device 200 in the low power mode. In one embodiment, the mobile computing device 200 in a close position may not be powered off but may be placed in a low power consumption or suspended mode. Other methods of recognizing the closed position and adjusting the power may also be used.

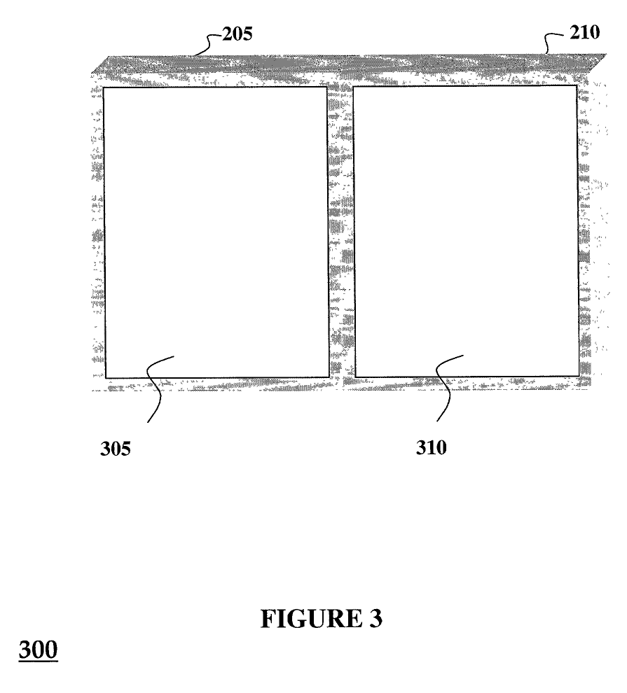

FIG. 3 is an illustration of two exemplary attached modules unfolded in an open position. The mobile computing device 300 may have the module 210 and the module 205 arranged side by side. The display screens 310, 305 of the modules 210 and 205 respectively are adjacent to each other. This is referred to as an open position. The open position provides a large display area (and thus a large viewing area) using both of the display screens 305 and 310. For example, using the exemplary dimensions of the module described in FIG. 1, the display area may have a dimension of 20 cm×14 cm×2 cm. Using the open position, the mobile computing device 300 may have a display area that is at least twice the size of display areas of other pocketsize mobile computing devices. The large display area enables Web browing using the mobile computing devie 300 to be easier than using the existing pocketsize mobile computing devices.

In one embodiment, when the mobile computing device 300 is opened from its close position, the power is switched on or resumed from its low power setting. For example, the power may be switched on when by a switch attached to the hinge. Other methods of powering on the mobile computing device 300 may also be used. In one embodiment, a pen-like device (e.g., pen used with the Palm Pilot PDA, etc.) is used as an input device to be used with the touch screen display (as described in FIG. 1).

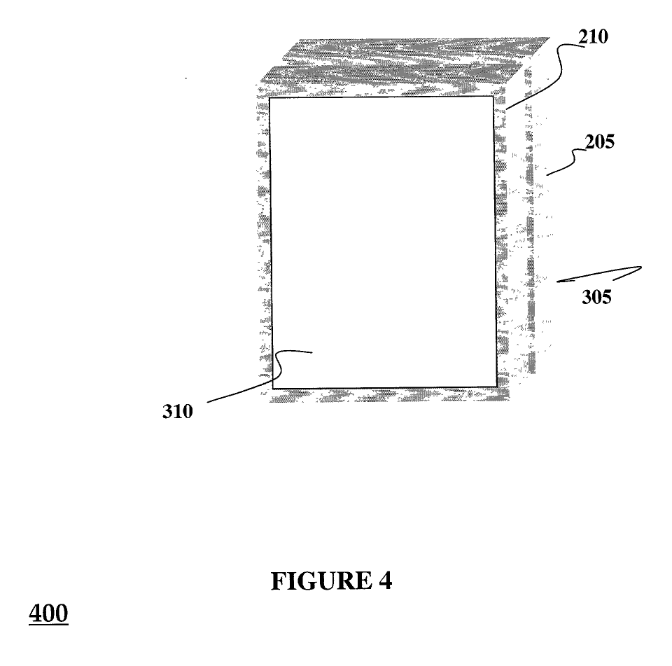

FIG. 4 is an exemplary illustration of two modules folded in a back-to-back open position. Note that in this folded back-to-back position, the mobile computing device 400 has the module 210 on top of the module 205. Furthermore, in this position, the mobile computing device 400 shows the display screen 310 in the front side and the display screen 305 in the back side. Thus, the mobile computing device 400 has a display scrren visible on both sides. This position is referred to as a note position. In one embodiment, the mobile computing device 400 in the note position may be used as a handheld device such as, for example, a PDA. The display screen 310 may be used as the display screen for the mobile computing device 400. When the mobile computing device 400 is placed in the note position, appropriate software is activated to put the mobile computing device into a PDA mode and PDA-specific applications may be started. In another embodiment, the display screen 305 on the back side of the mobile computing device 400 may be used for another PDA application.

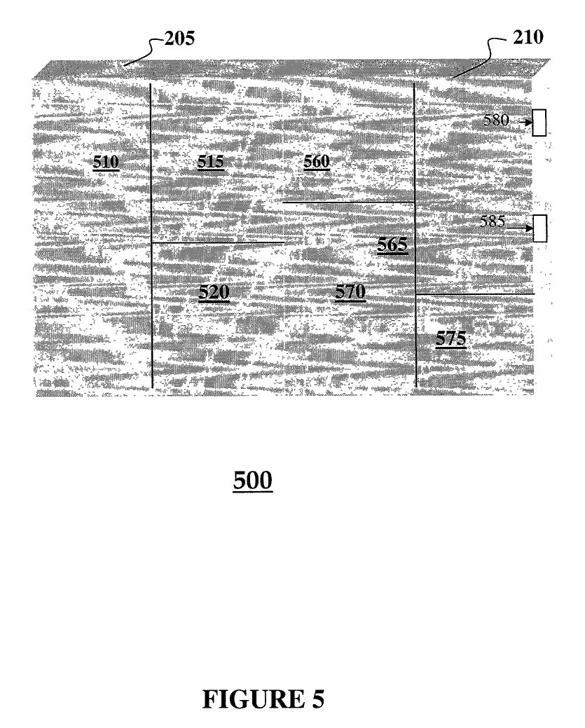

FIG. 5 is an exemplary illustration of internal components in a mobile computing device according to the present invention. The mobile computing device 500 includes the modules 210 and 205. The arrangement of the modules 210 and 205 is similar to the arrangement described in FIG. 3 in the open position. Generally, a computer system has multiple components including, for example, a processor, a chipset, a bus, memory, communication, power or battery, etc. In one embodiment, the components in the computer system are distributed among the modules used to form the mobile computing device 500. For example, the module 205 may include a battery pack 510, a microprocessor 520 (e.g., an off the shelf mobile processor, etc.) and a display chipset 515. The module 210 may include a memory 560, a long-term storage 570, a built-in cellular phone 565, and a wireless communication adapter 575. The memory 560 may be part volatile DRAM and part non-volatile flash memory, or any combination of them. The module 210 may also include a speaker 580 and a microphone 585. The microphone 585 may be used to record and store voice in digital format.

In one embodiment, to save power, space and to allow the mobile computing device 500 to be small and light, the mobile computing device 500 may implement some functions in software. For example, a mouse may be substituted by using a pen device (e.g., pen used with Palm Pilot PDA, etc.) in conjunction with the touch screen, a keyboard can be implemented using a sofware emulation and keyboard input may be achieved using the pen device with the touch screen, communication ports may be implemented using wireless technology (e.g., Intel Bluetooth technology, etc.). The mobile computing device 500 may use wireless technology for short-range communication and the cellular phone 565 for long-range communication.

In one embodiment, the mobile computing device 500 uses an embedded operating system (OS) (e.g., Windows-CE). This may allow the mobile computing device 500 to save memory requirement. After a first boot up process, an image of the OS is stored in a flash memory. Each subsequent usage of the mobile computing device 500 will resume from a previous state of the mobile computing device 500. In one embodiment, the mobile computing device 500 is not powered off even when it is in the close position, as described in FIG. 2.

In one embodiment, since the mobile computing device 500 may operate as a laptop computer, the amount of memory in the mobile computing device 500 may be more than the amount of memory used in existing PDAs. This allows the mobile computing device to accommodate laptop software applications (e.g., Microsoft Word, etc.) that may require more memory than applications written for the PDAs.

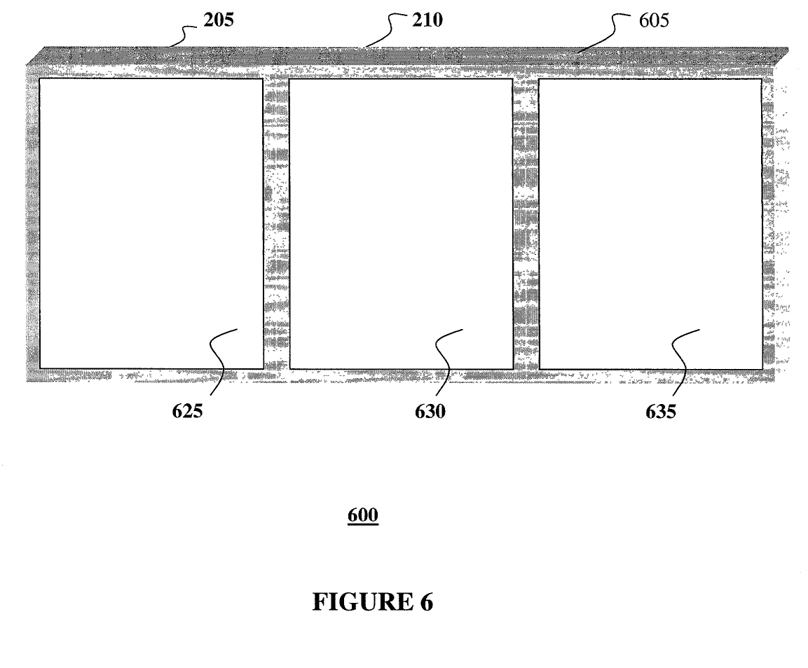

FIG. 6 is an exemplary illustration of a mobile computing system with three modules in the side-to-side open position. The mobile computing system described herein may comprise of multiple modules depending on desired implementations. Having multiple modules allow the mobile computing device 600 to have an even larger combined display screen as thus a larger viewing area. Referring to FIG. 6, the modules 205, 210 and 605 are attached to each other to form a mobile computing system 600. The three display screens 625, 630 and 635 positioned side-by-side to illustrate the large combined display screen. The three modules may be folded together to enable the mobile computing system 600 to perform handheld functions such as, for example, those functions in a PDA. In one embodiment, when the three modules 205, 210 and 605 are folded together, the display screen 625 is used while the display screens 630 and 635 are folded facing each other. The back side of the module 605 becomes the back side of the folded mobile computing system 600.

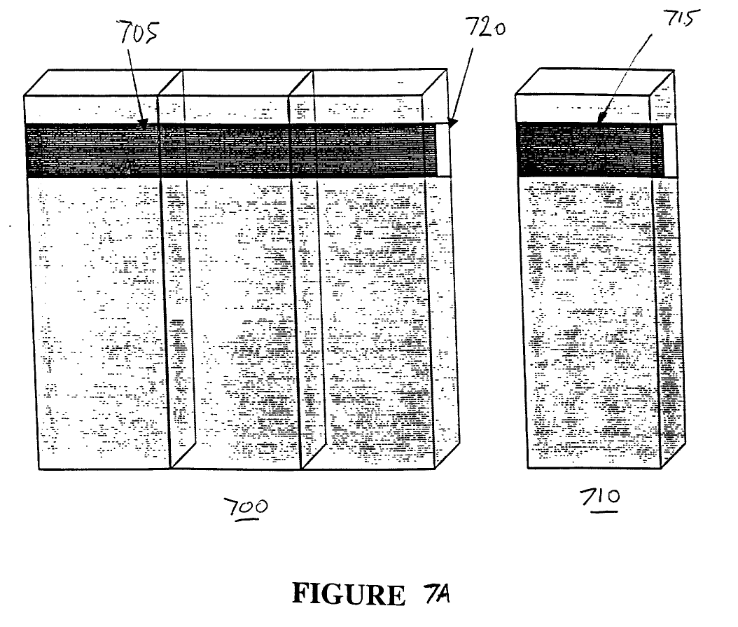

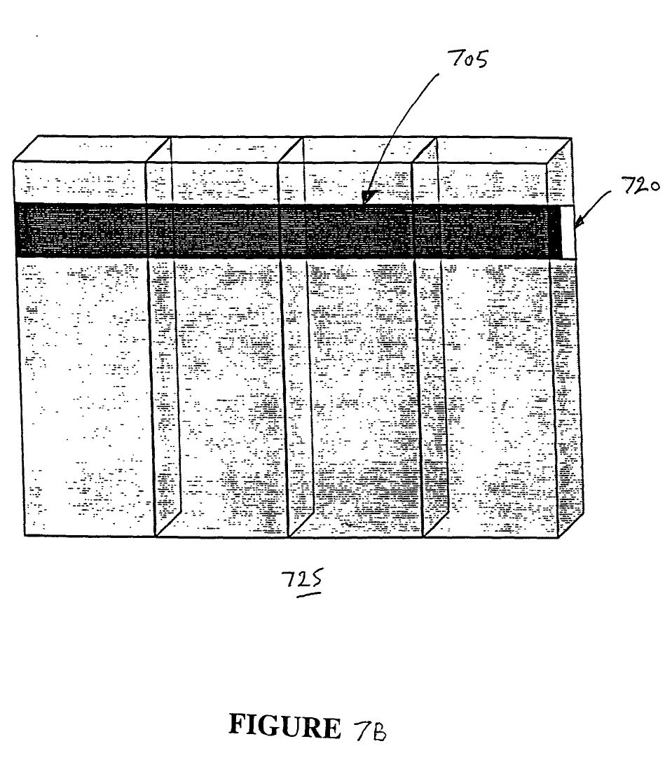

FIGS. 7A and 7B provide exemplary illustration of a mobile computing device having multiple modules. Referring to FIG. 7A, the module 710 may be attached to the group of modules 700 at location 720. The location 720 may include a connector to allow the module 710 to be quickly snapped into and attached with the group of modules 700. In one embodiment, the location 720 may also include a bus connection to allow the module 710 and its bus 715 to be connected with bus 705 of the group of modules 700 forming one continuous bus. A module in the group of modules 700 or the module 710 may be individually removed and replaced when upgrade is necessary. This allows for upgradability and scalability.

The modular approach described herein allows multiple modules to be joined or attached together to form a flexbible mobile computing device 725, as illustrated in FIG. 7B. For example, the open position is used to operate as a laptop computer; the note position is used to operate as a cellular phone or a handheld device, etc. The modular approach also allows for ease of portability similar to other handheld devices. In addition, the mobile computing device 725 may be easily configured by installing appropriate software corresponding to the desired configurations (e.g., laptop, PDA, cellular phone, etc.).

From the above description and drawings, it will be understood by those of ordinary skill in the art that the particular embodiments shown and described are for purposes of illustration only and are not intended to limit the scope of the invention. Those of ordinary skill in the art will recognize that the invention may be embodied in other specific forms without departing from its spirit or essential characteristics. References to details of particular embodiments are not intended to limit the scope of the claims.

What is claimed is:

1. A system, comprising:
at least two modules coupled to one another, each of the at least two modules having a display screen,
wherein a display screen of a first module and a display screen of a second module form a first viewing area when the first module is placed adjacent to the second module,
wherein the first module and the second module have components forming a computer.

2. The system of claim 1, wherein when the first module is folded over the second module such that neither the display screen of the first module nor the display screen of the second module is visible, a low power-consumption mode is set.

3. The system of claim 1, wherein when the first module is folded over the second module such that the display screen of the first module is visible, the display screen of the first module forms a second viewing area.

4. The system of claim 1, wherein the display screens of the first and second module are touch screen.

5. The system of claim 4, further comprising a pen input device.

6. The system of claim 1, further comprising keyboard simulation software.

7. The system of claim 1, wherein the first module further comprises a wireless communication device and a voice-recording device.

8. The system of claim 1, wherein the second module is upgraded by uncoupling the second module from the first module and coupling an upgraded second module to the first module.

9. A method, comprising:
coupling a first module and a second module to form a computer system, each of the first and the second modules having a display screen, the first module and the second module having components forming a computer system; and
using the display screen of the first module and the display screen of the second module as a first viewing area to interact with applications configured to run with the computer system having the first viewing area.

10. The method of claim 9, wherein using the display screen of the first module and the display screen of the second module comprises placing the display screen of the first module adjacent to the display screen of the second module.

11. The method of claim 9, further comprising using the display screen of the first module as a second viewing area to interact with applications configured to run with the computer system having the second viewing area.

12. The method of claim 11, wherein using the display screen of the first module as the second viewing area comprises overlapping the first module with the second module such that the display screen of the first module is visible.

13. The method of claim 9, further comprising using a pen input device to interact with the computer system.

14. The method of claim 13, wherein the display screen of the first module and the display screen of the second module are touch-screen.

15. The method of claim 9, further comprising upgrading the second module by uncoupling the second module from the first module and coupling an upgraded second module with the first module.

16. The method of claim 9, further comprising closing the computer system by overlapping the first module with the second module such that neither the display screen of the first module nor the display screen of the second module is visible.

17. The method of claim 16, wherein closing the computer system comprises setting a power level of the computer system to a low power-consumption mode.

18. A system, comprising:
means for coupling two or more modules, wherein each of a first module and a second module has a first display screen and a second display screen respectively such that when the first module and the second module are placed adjacent to each other, the first display screen and the second display screen forming a viewing area, the first module and the second module having components required to form a computer system; and
means for activating applications corresponding to the viewing area.

19. The system of claim 18, further comprising means for setting a low power-consumption mode when the first module is folded over the second module such that neither the first display screen or the second display screen is visible.

20. The system of claim 18, further comprising means for activating applications corresponding to a viewing area formed by the first display screen when the first module is folded over the second module such that only the first display screen is visible.

21. A system, comprising:
a planar display formed by joining two or more modules,
wherein each of the two or more modules providing a proportionate amount of the planar display, and
wherein the two or more modules having components to form a computer located behind the planar display.

22. The system of claim 21, wherein components in a first module is replaced by disjoining the first module from the computer and joining a different first module to the computer.

23. The system of claim 21, wherein the two or more modules are folded to place the computer into different shapes.

24. The system of claim 23, wherein the two or more modules are folded into a pocket size shape.
